(19) United States
(12) Patent Application Publication
(10) Pub. No.: US 2025/0297723 A1
(43) Pub. Date: Sep. 25, 2025

(54) HEAT DISSIPATION METHOD OF VEHICLE LED LAMP, APPARATUS, ELECTRONIC DEVICE, AND STORAGE MEDIUM

(71) Applicant: Easdar Optoelectronics(Guangdong) Co.,Ltd, Zhongshan (CN)

(72) Inventors: Baozhou XU, Zhongshan (CN); Liang ZHAO, Zhongshan (CN); Ziqiang QIU, Zhongshan (CN)

(73) Assignee: Easdar Optoelectronics(Guangdong) Co.,Ltd, Zhongshan (CN)

(21) Appl. No.: 18/944,004

(22) Filed: Nov. 12, 2024

(30) Foreign Application Priority Data
Mar. 21, 2024 (CN) 202410325996.7

(51) Int. Cl. F21S 45/43; F21S 41/141; F21S 43/14; F21S 45/46; G05D 7/06

(52) U.S. Cl. CPC F21S 45/43; F21S 45/46; G05D 7/0676; F21S 41/141; F21S 43/14

(57) ABSTRACT

A heat dissipation method of a vehicle light-emitting diode (LED) lamp is provided. When a vehicle lamp is turned on, an instruction, a temperature, luminance, a heat dissipation state, and an external environmental temperature of the vehicle lamp are acquired, and a heat dissipation strategy is adjusted. If the temperature of the vehicle lamp is greater than a first temperature threshold, a fan is started for heat dissipation. If the temperature of the vehicle lamp is continuously greater than a second temperature threshold, even though the fan operates at a full speed, a liquid cooling system is activated for cooling. When the external temperature reaches a preset threshold, the fan and the liquid cooling system work simultaneously, so as to control the temperature within a safety range. A cooling fan state and a liquid cooling state are respectively adjusted through a rotational speed and a flow velocity.

### CROSS REFERENCE TO THE RELATED APPLICATIONS

This application is based upon and claims priority to Chinese Patent Application No. 202410325996.7, filed on Mar. 21, 2024, the entire contents of which are incorporated herein by reference.

### TECHNICAL FIELD

The present disclosure relates to the technical field of heat dissipation of vehicle light-emitting diode (LED) lamps, and in particular to a heat dissipation method of a vehicle LED lamp, an apparatus, an electronic device, and a storage medium.

### BACKGROUND

In present automotive engineering, LED lamps have been widely applied to vehicle illuminating systems due to their high efficiency and high durability. With excellent luminance and excellent energy efficiency, these lamps have become indispensable in modern automotive design.

However, according to the prior art, the luminous efficiency of the LED lamp is affected greatly in a high-temperature environment to cause luminance decay. When the heat load of the LED lamp cannot be effectively managed by a vehicle heat dissipation system, and particularly the LED lamp operates at a high power for long time, the luminance decay is more obvious. This not only affects the illumination performance, but also makes a driver visually uncomfortable in nighttime or low-light conditions and increases the risk of traffic accidents.

### SUMMARY

In view of defects and shortages of the prior art, according to an aspect, the present disclosure provides a heat dissipation method of a vehicle LED lamp, including: in response to an illuminating state of a vehicle lamp, acquiring a vehicle lamp instruction, a vehicle lamp temperature, vehicle lamp luminance, a cooling fan state, a liquid cooling state, and an external environmental temperature of the vehicle lamp;
based on the vehicle lamp instruction, the vehicle lamp temperature, the vehicle lamp luminance, the cooling fan state, the liquid cooling state, and the external environmental temperature of the vehicle lamp, as well as a preset first temperature threshold, adjusting heat dissipation data of the vehicle lamp; and
adjusting the cooling fan state according to the vehicle lamp temperature in the vehicle lamp instruction: in response to passive heat dissipation and the vehicle lamp temperature being greater than the first temperature threshold, starting a cooling fan to lower the vehicle lamp temperature to the first temperature threshold or below, and adjusting the liquid cooling state according to the vehicle lamp temperature in the vehicle lamp instruction: in response to a maximum rotational speed of the cooling fan and the vehicle lamp temperature still being greater than a second temperature threshold, starting liquid cooling to further lower the vehicle lamp temperature to the second temperature threshold or below, and regardless of a value of the vehicle lamp temperature, when the external environmental temperature reaches an environmental temperature threshold, starting the cooling fan and the liquid cooling simultaneously,

The cooling fan state includes start/stop of the cooling fan and a rotational speed of the cooling fan; and the liquid cooling state includes start/stop of the liquid cooling, and a flow velocity of a cooling liquid.

According to another aspect, an embodiment of the present disclosure further provides a vehicle LED lamp, including a housing and a thermal superconductive tube provided in the housing, where an accommodating cavity and a heat dissipation cavity are formed in the housing; an LED module and a vehicle LED lamp heat dissipation apparatus are provided in the accommodating cavity; the thermal superconductive tube includes a heat conducting section and a cooling section; the heat conducting section contacts the LED module; the cooling section is wound in the heat dissipation cavity and contacts an inner wall of the heat dissipation cavity; the thermal superconductive tube is configured to conduct heat generated by illumination of the LED module to the housing and the heat dissipation cavity; a heat dissipation apparatus is provided in the heat dissipation cavity; the heat dissipation apparatus is opposite to the cooling section; and the vehicle LED lamp heat dissipation apparatus is electrically connected to the LED module;
the vehicle LED lamp heat dissipation apparatus includes:
a preset module, configured to determine the first temperature threshold, the second temperature threshold, and the environmental temperature threshold correspondingly according to the vehicle lamp instruction;
a first data acquisition unit, configured to acquire the vehicle lamp instruction;
a second data acquisition unit, configured to acquire the vehicle lamp temperature, the vehicle lamp luminance, the cooling fan state, the liquid cooling state, and the external environmental temperature of the vehicle lamp in real time;
an output constructor, configured to evaluate a consistency between actual data and preset data, and generate a required rotational speed adjusted value based on a comparison; and
a control module, configured to start and adjust the cooling fan or the liquid cooling according to a received start signal;
the vehicle lamp instruction includes at least a low beam (LB) sub-instruction, a high beam (HB) sub-instruction, a daytime running lamp (DRL) sub-instruction, a turn signal lamp sub-instruction, and a fog lamp sub-instruction; and
the control module includes:
an air cooling control module, configured to send, when the vehicle lamp temperature is greater than a corresponding threshold, an air cooling start signal to a controller, and adjust the cooling fan state according to the vehicle lamp temperature or the environmental temperature; and
a liquid cooling control module, configured to send, when the vehicle lamp temperature is greater than the second temperature threshold or the environmental temperature is greater than the environmental temperature threshold, a liquid cooling start signal to the controller, and adjust the liquid cooling state according to the vehicle lamp temperature or the environmental temperature.

With the above technical solutions, the present disclosure has the following beneficial effects:

The present disclosure can improve luminous efficiency of the LED lamp significantly, and particularly keep stable light output in the high-temperature environment to prevent luminance decay. The present disclosure improves heat dissipation efficiency to prolong the service life of the LED lamp and reduce the maintenance cost, and provides more reliable illumination to improve the driving safety in nighttime and low-light conditions.

### BRIEF DESCRIPTION OF THE DRAWINGS

FIG. 1 is a structural view of a vehicle LED lamp according to Embodiment 1 of the present disclosure;

FIG. 2 is a side view of the vehicle LED lamp according to Embodiment 1 of the present disclosure;

FIG. 3 is a perspective view of a vehicle LED lamp according to Embodiment 2 of the present disclosure;

FIG. 4 is a flowchart of a heat dissipation method of a vehicle LED lamp according to Embodiment 1 of the present disclosure;

FIG. 5 is a schematic flowchart of S13 according to Embodiment 1 of the present disclosure;

FIG. 6 is a structural view of a vehicle LED lamp heat dissipation apparatus according to Embodiment 2 of the present disclosure;

FIG. 7 is a detailed structural view of a control module in FIG. 6; and

FIG. 8 is a structural view of a computer device according to another embodiment of the present disclosure.

### DETAILED DESCRIPTION OF THE EMBODIMENTS

Embodiments described in the present disclosure are a part of embodiments of the present disclosure. Generally, components of the embodiments of the present disclosure described and shown in the accompanying drawings may be arranged and designed in various manners. The following detailed description on the embodiments of the present disclosure in the accompanying drawings is not intended to limit the protection scope of the present disclosure, but merely indicates selected embodiments of the present disclosure.

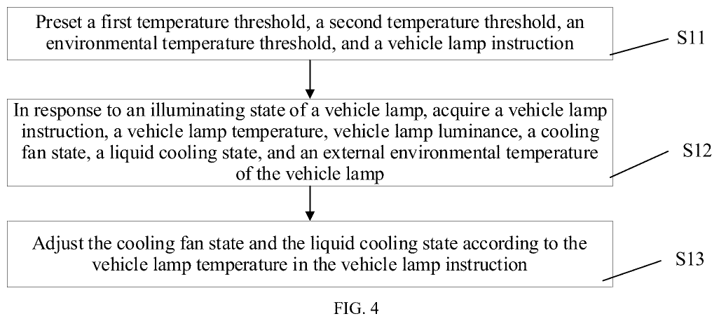

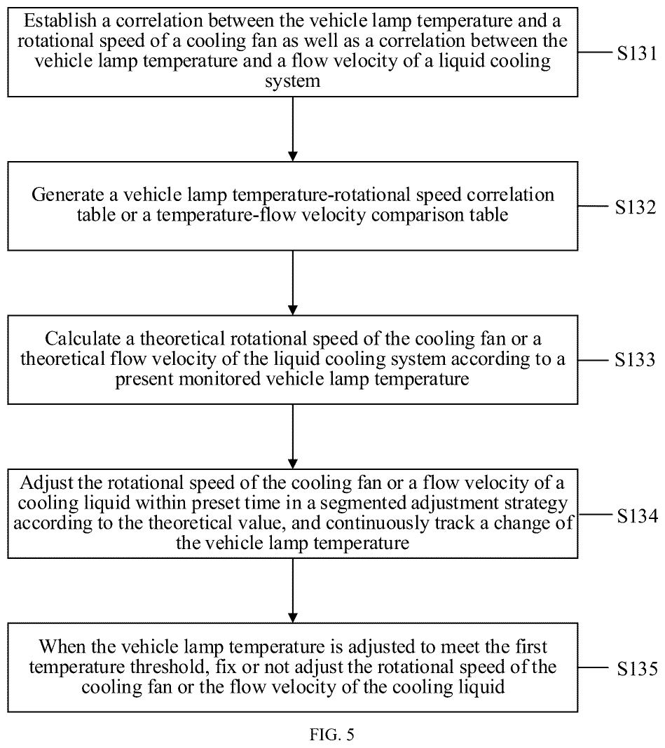

Embodiment 1: As shown in FIG. 4 to FIG. 5, the embodiment provides a heat dissipation method of a vehicle LED lamp, including steps S11-S13. Specifically:

S11: A first temperature threshold, a second temperature threshold, an environmental temperature threshold, and a vehicle lamp instruction are preset.

In the embodiment, various vehicle lamp operating instructions and corresponding control algorithms are preset in a management unit of the vehicle LED lamp, so as to automatically activate the corresponding light mode according to the specific scene. By comparing a predefined test standard, such as a predefined illumination intensity and a predefined rotational speed of the fan, with real-time acquired data, whether the speed of the fan is to be adjusted to match a present light level is evaluated, thereby ensuring that the vehicle LED lamp operates in an optimal state. By presetting the first temperature threshold, the second temperature threshold, the environmental temperature threshold, and the vehicle lamp instruction, the heat dissipation method of a vehicle LED lamp can control a heat dissipation response accurately, and adjust a strategy according to the environmental temperature, so as to adapt to different weathers, prevent overheating, lower the risk of lamp damage, and improve the driving safety. The heat dissipation method of a vehicle LED lamp can adjust the heat dissipation intensity and the luminance intelligently for energy saving, provide the stable and comfortable illumination effect, and improve the user experience. The method makes the LED lamp more efficient and reliable, and realizes flexible illumination control.

S12: In response to an illuminating state of a vehicle lamp, a vehicle lamp instruction, a vehicle lamp temperature, vehicle lamp luminance, a cooling fan state, a liquid cooling state, and an external environmental temperature of the vehicle lamp are acquired, to evaluate a working condition and an external environment of the vehicle lamp comprehensively, thereby realizing accurate and dynamic temperature management. The method not only ensures optimal performance of the vehicle lamp in various environments and prolongs the service life of the vehicle lamp, but also can optimize the heat dissipation efficiency according to real-time data to prevent the overheating and improve the energy efficiency. Meanwhile, the method ensures the illuminating quality, and improves the driving safety and the user experience.

S13: The cooling fan state and the liquid cooling state are adjusted according to the vehicle lamp temperature in the vehicle lamp instruction.

The method for adjusting the state of the cooling fan and the state of the liquid cooling system according to the vehicle lamp instruction has the following significant advantages: The actual operating condition of the vehicle lamp can be adapted dynamically, to ensure that the heat can be managed effectively at any illumination intensity. The method improves the luminous efficiency and the service life of the lamp, prevents performance degradation caused by the overheating, and reduces the energy consumption. By accurately controlling the heat dissipation, the driving environment is safer, the sudden luminance change caused by an overhigh temperature is prevented, the stability and reliability of the vehicle lamp are ensured, and the nighttime driving is more comfortable visually and safer.

Therefore, the present disclosure in the first embodiment can improve the luminous efficiency of the LED lamp significantly, and particularly keeps stable light output in the high-temperature environment to prevent luminance decay. The present disclosure improves the heat dissipation efficiency to prolong the service life of the LED lamp and reduce the maintenance cost, and provides more reliable illumination to improve the driving safety in nighttime and low-light conditions. In some embodiments, S13 may include:

S131: A correlation between the vehicle lamp temperature and a rotational speed of a cooling fan as well as a correlation between the vehicle lamp temperature and a flow velocity of a liquid cooling system is established. In the heat dissipation method of a vehicle LED lamp, by establishing the correlation between the vehicle lamp temperature and the rotational speed of the cooling fan as well as the correlation between the vehicle lamp temperature and the flow velocity of the liquid cooling system, the heat dissipation performance is adjusted accurately to meet an actual demand on a heat load. The method optimizes the heat dissipation efficiency, and lowers the overheating risk, thereby prolonging the service life of the vehicle LED lamp and maintaining the consistent light output. Meanwhile, by automatically adjusting operation of the heat dissipation system, the method can save the energy and reduce the operation and maintenance cost. The dynamic adjustment mechanism makes the vehicle lamp system more suitable for different environmental conditions, and can provide stable and reliable illumination in various weathers.

S132: A vehicle lamp temperature-rotational speed correlation table or a temperature-flow velocity comparison table is generated.

In the heat dissipation method of a vehicle LED lamp, by generating the correlation table between the vehicle lamp temperature and the rotational speed of the cooling fan or the comparison table between the vehicle lamp temperature and the flow velocity of the liquid cooling system, the following significant advantages can be achieved: With the table, the heat dissipation system can automatically adjust the rotational speed of the fan and the flow velocity based on a real-time temperature reading, thereby accurately controlling the heat dissipation performance. This not only optimizes the heat dissipation efficiency and lowers the overheating risk of the vehicle LED lamp, but also prolongs the service life of the vehicle LED lamp and maintains the stable light output. The automatic adjustment further improves the energy efficiency, and reduces the energy consumption. Meanwhile, the method makes the system more suitable for environmental changes, and ensures that the vehicle LED lamp can maintain the optimal performance in different weathers and different working conditions.

S133: A theoretical rotational speed of the cooling fan or a theoretical flow velocity of the liquid cooling system is calculated according to a present monitored vehicle lamp temperature.

In the heat dissipation method of a vehicle LED lamp, by calculating the theoretical rotational speed of the cooling fan or the theoretical flow velocity of the liquid cooling system based on the present monitored vehicle lamp temperature, the following significant advantages are achieved: With this strategy, the heat dissipation system can dynamically adapt to an actual heat load of the LED lamp, thereby accurately controlling the heat dissipation performance, and optimizing a working temperature of the LED lamp. This not only prolongs the service life of the LED lamp, but also maintains the light output stability and the light output efficiency. In addition, with dynamic adjustment on heat dissipation parameters, the energy consumption is saved, the unnecessary operation of the heat dissipation system is reduced, and the operation and maintenance cost is lowered. By adjusting the heat dissipation strategy in real time to meet the present temperature condition, the method makes the vehicle LED lamp system more reliable and safer in various environmental conditions, and improves the driving experience of the user.

S134: The rotational speed of the cooling fan or a flow velocity of a cooling liquid is adjusted within preset time through a segmented adjustment strategy according to the theoretical value, and a change of the vehicle lamp temperature is continuously tracked.

The method for adjusting the rotational speed of the fan or the flow velocity of the cooling liquid within the preset time in the segmented adjustment strategy according to the theoretical value, and continuously tracking the change on the vehicle lamp temperature has many advantages for heat dissipation of the vehicle LED lamp. The method makes the heat dissipation adjusted finer and more purposeful, can meet the real-time heat dissipation demand of the LED lamp more accurately to prevent overcooling or overheating, and ensures that the LED lamp is maintained at an optimal working temperature. The dynamic adjustment mechanism improves the heat dissipation efficiency, reduces the energy consumption, prolongs the service life of the LED lamp, and ensures the consistent luminous efficiency. The segmented adjustment further smooths the response of the heat dissipation system, and prevents the impact on the system for an abrupt change, thereby improving the stability and reliability of the system.

S135: When the vehicle lamp temperature is adjusted to meet the first temperature threshold, the rotational speed of the cooling fan or the flow velocity of the cooling liquid is fixed or not adjusted.

In the heat dissipation method of a vehicle LED lamp, when the vehicle lamp temperature is adjusted to reach the first temperature threshold, the rotational speed of the cooling fan or the flow velocity of the cooling liquid is fixed or not adjusted, which has the following significant advantages: The method prevents overcooling after the system reaches the desirable heat dissipation effect, thereby reducing the energy waste and maintaining the optimal energy efficiency. By maintaining stable operation of the heat dissipation system when necessary, the service life of the heat dissipation assembly can be prolonged to lower the maintenance cost. In addition, the strategy ensures that the vehicle LED lamp works at an optimal temperature, and keeps the stable luminous efficiency and the stable color temperature, thereby providing more reliable and consistent illumination effect, and improving the driving safety in nighttime or severe weathers. With intelligent control, the method optimizes the heat dissipation management, saves the energy, and improves the illumination quality.

The modules and units in the embodiment are in one-to-one correspondence with those in the steps of Embodiment 1, and are not repeated herein. The present disclosure is realized by acquiring the corresponding vehicle LED lamp instruction, invoking corresponding preset detection data, and comparing the preset detection data with actual detection data. When the actual detection data is not the same as the preset detection data, the present rotational speed in the vehicle LED lamp does not match with the present luminance of the vehicle LED lamp. That is, the present rotational speed in the vehicle LED lamp is too fast or too slow. According to a compensation amount of the rotational speed, the rotational speed in the vehicle LED lamp is adjusted, thereby achieving an optimal rotational speed matching with the present luminance, and improving the accuracy of the heat dissipation system.

### Embodiment 2

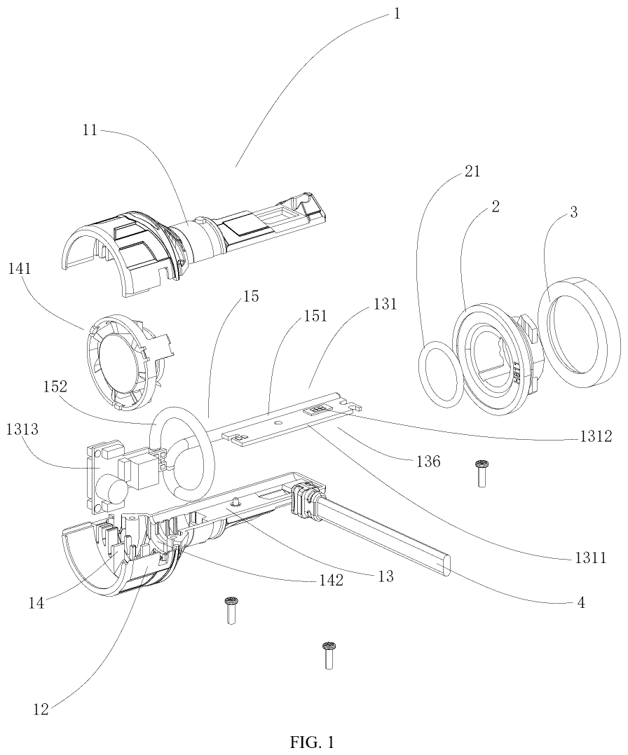

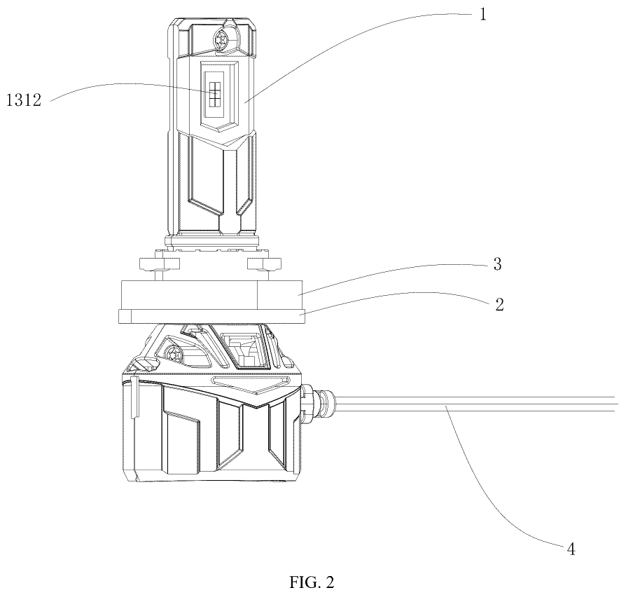

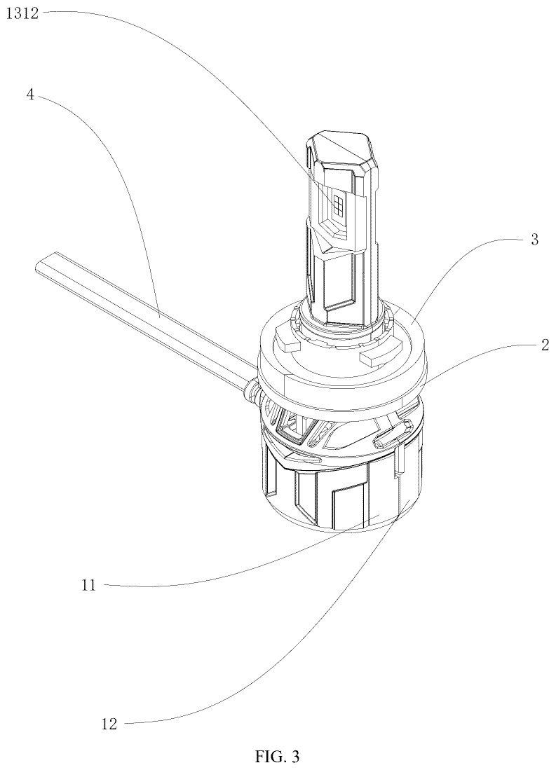

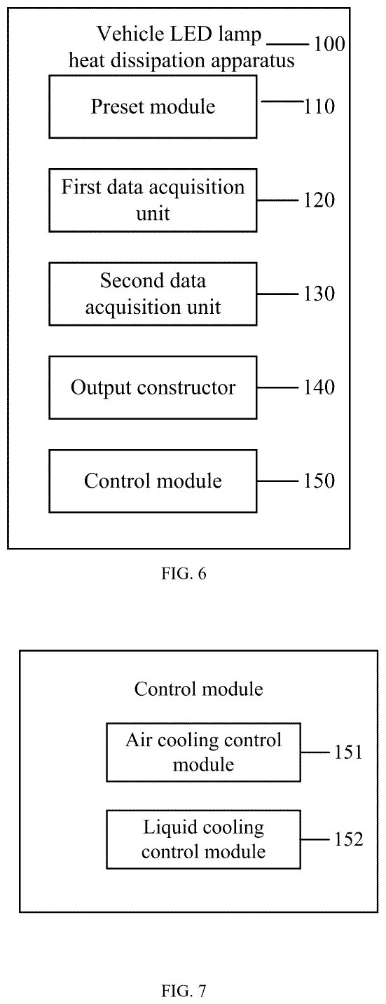

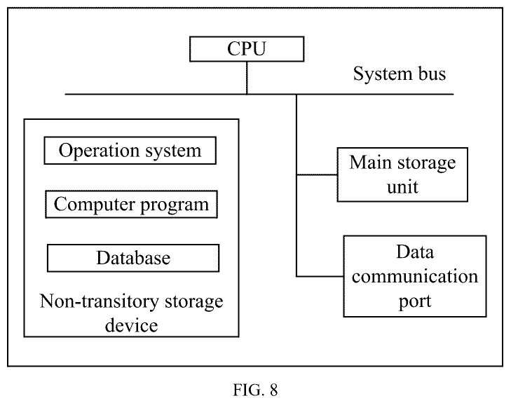

As shown in FIG. 1, FIG. 2, FIG. 3, FIG. 6 and FIG. 7, the embodiment provides a vehicle LED lamp, including a housing and thermal superconductive tube 15 provided in the housing. Accommodating cavity 13 and heat dissipation cavity 14 are formed in the housing. LED module 131 is provided in the accommodating cavity 13. The thermal superconductive tube 15 includes heat conducting section 151 and cooling section 152. The heat conducting section 151 contacts the LED module 131. The cooling section 152 is wound in the heat dissipation cavity 14 and contacts an inner wall of the heat dissipation cavity 14. The thermal superconductive tube 15 is configured to conduct heat generated by illumination of the LED module 131 to the housing and the heat dissipation cavity 14. Heat dissipation apparatus 141 is provided in the heat dissipation cavity 14. The heat dissipation apparatus 141 is opposite to the cooling section 152.

The vehicle LED lamp generates light through an LED light source, thus realizing an illumination effect. However, the LED light source generates a large amount of heat when emitting the light. If the heat cannot be dissipated timely, the lamp suffers from a temperature rise, and after the lamp works for long time, LED bead 1312 is aged and damaged. Hence, the thermal superconductive tube is used in the vehicle LED lamp to transfer the heat generated by the light source assembly to the inner wall. The vehicle LED lamp is cooled through the inner wall. This prevents the vehicle LED lamp from working in the high-temperature environment for long time, and alleviates the aging speed of the vehicle LED lamp, thereby prolonging the service life of the vehicle LED lamp. With a small size and a flexible shape, the thermal superconductive tube can be customized according to a layout and a space limitation of the vehicle LED lamp. In this way, the thermal superconductive tube can better adapt to the LED light source of various sizes and shapes to realize the compact heat dissipation design.

A temperature sensor serves as a metal thermal superconductive tube in the embodiment. In another embodiment, the thermal superconductive tube may further be a polymer thermal superconductive tube, a carbon nanotube (CNT) thermal superconductive tube, a ceramic thermal superconductive tube, etc.

In work, a working medium in the thermal superconductive tube is evaporated into high-temperature and high-pressure steam that fills an internal space of the whole tube fully. The steam is propagated quickly in a high-temperature region in the tube to absorb the heat from the heat source. When the steam reaches a cold end of the thermal superconductive tube, due to a low temperature of the cold end, the steam is condensed for a loss of heat. The heat is transferred to a cooling medium, such that the cooling medium is condensed into a liquid. Through a gravity and a capillary force, the liquid is reflowed along the inner wall of the tube to a hot end of the thermal superconductive tube, thereby realizing a closed circulation. The thermal superconductive tube can effectively improve the performance and reliability of the vehicle LED lamp, and has the high efficiency and the high energy saving property.

Further, the LED module 131 includes light source substrate 1311, the bead 1312 provided on the light source substrate 1311, and drive plate 1313 provided in the heat dissipation cavity 14. The heat conducting section 151 contacts one side of the light source substrate 1311. The drive plate 1313 is electrically connected to the light source substrate 1311. The drive plate 1313 is opposite to the heat dissipation apparatus 141.

By directly contacting the vehicle LED lamp, the thermal superconductive tube can make the heat uniformly distributed in the whole tube. This can prevent the local hot spot, and prevent luminance decay or damage in some region of the vehicle LED lamp for an overhigh temperature. To sum up, by directly contacting the LED light source, the thermal superconductive tube can improve the heat dissipation efficiency, and can ensure that the vehicle LED lamp works stably, has the longer service life, and adapts to various sizes and shapes. The thermal superconductive tube is considered as an efficient and reliable passive heat dissipation solution.

Further, groove 142 is further formed in the heat dissipation cavity 14. The groove 142 is configured to accommodate and fix the cooling section 152.

There is one circle of cooling section 152 or more. A number of grooves 142 changes correspondingly with a number of cooling sections 152.

The groove can provide a larger contact area, such that the thermal superconductive tube contacts the LED bead 1312 better. This realizes more effective heat transfer and dissipation and can further make the heat uniformly distributed to prevent the local hot spot. Meanwhile, by placing the thermal superconductive tube in the groove, the thermal superconductive tube can be protected better from the external environment. The groove can provide certain physical protection to lower a risk of damage or pollution on the thermal superconductive tube.

In short, the thermal superconductive tube provided in the groove of the vehicle LED lamp can provide better heat dissipation effect, dissipate the heat uniformly, make the design compact, and improve the serviceability and reliability. This contributes to high performance and long service life of the vehicle LED lamp.

Further, the housing further includes first housing 11 and second housing 12. The first housing 11 and the second housing 12 are fixed by a fastening screw. The vehicle LED lamp fixed by the fastening screw has advantages of stability, safety, adjustability and easy maintenance. This can make the vehicle lamp stable and reliable in driving to provide the optimal illumination effect, and facilitates maintenance and replacement.

Further, chuck 2 and sealing ring 21 are further provided outside the first housing 11 and the second housing 12. The chuck 2 is configured to fix the first housing 11 and the second housing 12, and support a connecting piece between the LED module 131 and the heat dissipation apparatus 141. The sealing ring 21 is located in the chuck 2, and configured to ensure desirable airtightness between the chuck 2 and the external environment.

The chuck and the sealing ring can effectively prevent moisture and dust from entering the vehicle LED lamp to damage circuits and components in the vehicle LED lamp, thereby prolonging the service life of the vehicle LED lamp. With the chuck and the sealing ring, the vehicle LED lamp is mounted more conveniently and quickly, without any special tool. This can reduce the time and cost for mounting and maintenance.

Further, waterproof ring 3 is further provided outside the first housing 11 and the second housing 12. The waterproof ring 3 is connected to the chuck 2, and configured to prevent moisture, damp, dust and other impurities from entering the housing.

The waterproof ring is made of soft rubber or silica gel. The waterproof ring has desirable sealing performance, and can effectively prevent the moisture and the damp from permeating into the vehicle LED lamp. This can prevent the moisture from damaging components such as a circuit board, a connector and the lamp bead 1312, and improve the durability of the vehicle LED lamp.

Further, power cord 4 is further provided between the first housing 11 and the second housing 12. The power cord 4 is connected to the drive plate 1313.

The heat dissipation apparatus 141 is a cooling fan.

The chuck and the waterproof ring are an H8 model.

The cooling fan used by the vehicle LED lamp has the advantages of better heat dissipation effect, higher luminance and stability, higher safety, high cost performance, higher durability, low noise, etc. The cooling fan can effectively prolong the service life of the vehicle LED lamp, and provide the safer and more reliable illumination effect.

When the thermal superconductive tube works, the working medium is evaporated into high-temperature and high-pressure steam that fills an internal space of the whole tube fully. The steam is propagated quickly in a high-temperature region in the tube to absorb the heat from the heat source. When the steam reaches a cold end of the thermal superconductive tube, due to a low temperature of the cold end, the steam is condensed for a loss of heat. The heat is transferred to a cooling medium, such that the cooling medium is condensed into a liquid. Through a gravity and a capillary force, the liquid is reflowed along the inner wall of the tube to a hot end of the thermal superconductive tube, thereby realizing a closed circulation. The thermal superconductive tube can effectively improve the performance and reliability of the vehicle LED lamp, and has the high efficiency and the high energy saving property.

In some embodiments, a vehicle LED lamp heat dissipation apparatus 100 further includes a preset module, a first data acquisition unit, a second data acquisition unit, an output constructor, and a control module.

The preset module 110 is configured to store operating parameters of the heat dissipation system, such as a temperature threshold, a preset value of the rotational speed of the fan, and a preset value of the flow velocity of the cooling liquid, so as to allow a quick access and adjustment on a heat dissipation strategy, and flexibly configure heat dissipation parameters according to different working conditions and different environmental demands, thereby optimizing the heat dissipation effect.

The first data acquisition unit 120 is configured to acquire temperature data of the vehicle lamp, and monitor a real-time temperature of the vehicle LED lamp. Monitoring the temperature in real time ensures a prompt response of the heat dissipation system for a temperature change, thereby preventing the overheating, prolonging the service life of the vehicle LED lamp, and maintaining the stable light output.

The second data acquisition unit 130 is configured to acquire performance data of the heat dissipation system, such as the rotational speed of the fan and the flow velocity of the cooling liquid, so as to monitor performance of the heat dissipation system, and ensure that the heat dissipation apparatus operates according to preset parameters, thereby improving the heat dissipation efficiency and the energy utilization efficiency.

The output constructor 140 is configured to generate an adjustment instruction or report of the heat dissipation system according to information provided by the data acquisition unit, so as to realize conversion from data to an action, automatically adjust the heat dissipation strategy, optimize the heat dissipation effect, and provide a clear feedback for an operating state of the system.

The control module 150 is configured to receive the instruction of the output constructor, adjust the rotational speed of the cooling fan or the flow velocity of the cooling liquid, control actual operation of the heat dissipation apparatus, ensure an accurate response of the heat dissipation system through a core control capability, adjust a heat dissipation intensity according to an actual demand, and improve adaptability and efficiency of the system.

In some embodiments, the control module 150 may include: an air cooling control module and a liquid cooling control module.

The air cooling control module is configured to manage an operating state of the cooling fan, including starting the cooling fan, stopping the cooling fan, adjusting a rotational speed of the cooling fan, etc. The air cooling control module is configured to dynamically adjust the rotational speed of the fan according to the real-time temperature and the preset temperature threshold of the vehicle LED lamp, so as to optimize the heat dissipation effect. The air cooling control module can realize accurate temperature management, and prevent the vehicle LED lamp from overheating to prolong the service life. By adjusting the rotational speed of the fan, the air cooling control module can effectively control the noise, and improve the user experience. The air cooling control module ensures the efficient energy utilization, realizes heat dissipation only when necessary, and can reduce the energy waste.

The liquid cooling control module is configured to control operation of the liquid cooling system, including the flow velocity of the cooling liquid and the circulation of the cooling liquid.

The liquid cooling control module is configured to adjust the flow velocity of the cooling liquid according to the real-time working state of the vehicle lamp and the environmental temperature, so as to provide more effective heat dissipation. The liquid cooling control module has a more effective heat dissipation capability than the air cooling control module, and is suitable for a high-power LED lamp to keep the luminous efficiency and the stability. The liquid cooling control module can control the temperature more accurately, and makes the heat dissipated more uniformly and efficiently, The liquid cooling control module reduces the thermal resistance of the system, makes a quick response to the temperature change, and effectively prevents the temperature peak.

With the above two modules, the vehicle LED lamp heat dissipation apparatus can be suitable for more extensive working environments and application demands, and ensures that the vehicle LED lamp can maintain the optimal performance and the optimal service life in various conditions. With the intelligent control, the heat dissipation system can improve the energy efficiency, and can optimize the illumination quality and the user experience.

The modules and units in the embodiment are in one-to-one correspondence with those in the steps of Embodiment 1, and are not repeated herein.

Those skilled in the art can clearly understand that, for convenience and conciseness of description, only the division of the foregoing function modules is used as an example. In practical applications, the foregoing functions may be allocated to and completed by different function modules as required, that is, an internal structure of the apparatus is divided into different function modules to complete all or some of the functions described above. For a specific working process of the system, apparatus, and unit described above, refer to the corresponding process in the foregoing method embodiments. Details are not described herein again.

As shown in FIG. 8, an embodiment of the present disclosure provides a computer storage medium for a heat dissipation method of a vehicle LED lamp, including a computer program executable to a processor. The computer storage medium is intended to execute a heat dissipation management process by instructing hardware. The storage medium can be configured to store the heat dissipation method in the embodiment, including a possibility for programming heat dissipation control with a nonvolatile memory and a volatile memory. The nonvolatile memory is a read-only memory (ROM), a programmable ROM (PROM), an erasable programmable ROM (EPROM), an electrically erasable programmable ROM (EEPROM), a flash memory, and the like, and provides non-transitory storage for the program. The volatile memory is various random access memories (RAMs), and provides a temporary data processing space. With this design, the vehicle LED lamp heat dissipation system can realize automatic and accurate temperature control, optimize the heat dissipation efficiency, prolong the service life of the LED lamp, and improve the energy utilization efficiency. With the computer program for controlling related hardware to realize the heat dissipation management, the system is more flexible and more reliable.

Alternatively, the technical solution provided by the present disclosure may be implemented in a form of a software product. When sold or used as an independent product, the software product is stored in the computer-readable storage medium. This makes a computer device such as a personal computer (PC), a server or network hardware implement the method in the present disclosure by executing a predefined instruction. The instruction is intended to realize a special heat dissipation management process, and make the vehicle LED lamp system more efficient and reliable. There are a variety of storage media, including a mobile hard disk drive (HDD), a memory card, an ROM, a magnetic disk and a compact disc, so as to facilitate storage and transmission of a program code. Therefore, the present disclosure is applied more flexibly, and implemented and promoted easily.

An embodiment of the present disclosure further relates a computer device. The computer device is integrated with a storage unit, a processing unit, and a software program pre-installed in the storage unit and executable on the processing unit. When the program is run by the processing unit, a series of methods for the vehicle LED lamp heat dissipation management can be realized, which is the same as the description in the foregoing embodiment.

The computer device may also be a computer device with a comprehensive function, and its structure supports the realization of the vehicle LED lamp heat dissipation management method. The device is integrated with a plurality of key assemblies through a system bus, including a central processing unit (CPU), a storage unit, a data communication port, a display, and an input device. The CPU is configured to execute a computational task and control a logic. The storage unit includes a non-transitory storage device and a RAM, which are respectively configured to store an operation system and an application program, and support an operating environment of the operation system and an operating environment of the application program. With the data communication port, the device can be connected to an external network for data exchange. When executing a special software program, the device realizes an efficient heat dissipation control strategy of the vehicle LED lamp through the hardware assembly. With the display (which may be a liquid crystal display (LCD) or an e-ink screen) and various input options (a touch screen, a physical keyboard, a trackball or an external device), the user interaction experience is improved. This makes the device user-friendly and efficient when a heat dissipation management program is executed.

1. A heat dissipation method of a vehicle light-emitting diode (LED) lamp, comprising:
in response to an illuminating state of a vehicle lamp, acquiring a vehicle lamp instruction, a vehicle lamp temperature, vehicle lamp luminance, a cooling fan state, a liquid cooling state, and an external environmental temperature of the vehicle lamp;
based on the vehicle lamp instruction, the vehicle lamp temperature, the vehicle lamp luminance, the cooling fan state, the liquid cooling state, the external environmental temperature of the vehicle lamp and a preset first temperature threshold, adjusting heat dissipation data of the vehicle lamp; and
adjusting the cooling fan state according to the vehicle lamp temperature in the vehicle lamp instruction: in response to passive heat dissipation and the vehicle lamp temperature being greater than the preset first temperature threshold, starting a cooling fan to lower the vehicle lamp temperature to the preset first temperature threshold or below, and adjusting the liquid cooling state according to the vehicle lamp temperature in the vehicle lamp instruction: in response to a maximum rotational speed of the cooling fan and the vehicle lamp temperature still being greater than a second temperature threshold, starting liquid cooling to further lower the vehicle lamp temperature to the second temperature threshold or below, and regardless of a value of the vehicle lamp temperature, when the external environmental temperature reaches an environmental temperature threshold, starting the cooling fan and the liquid cooling simultaneously;
wherein the cooling fan state comprises start/stop of the cooling fan and a rotational speed of the cooling fan; and the liquid cooling state comprises start/stop of the liquid cooling, and a flow velocity of a cooling liquid.

2. The heat dissipation method of the vehicle LED lamp according to claim 1, wherein the vehicle lamp instruction comprises at least a low beam (LB) sub-instruction, a high beam (HB) sub-instruction, a daytime running lamp (DRL) sub-instruction, a turn signal lamp sub-instruction, and a fog lamp sub-instruction; and the preset first temperature threshold, the second temperature threshold, and the environmental temperature threshold are different in the LB sub-instruction, the HB sub-instruction, the DRL sub-instruction, the turn signal lamp sub-instruction, and the fog lamp sub-instruction.

3. The heat dissipation method of the vehicle LED lamp according to claim 1, wherein the step of adjusting the cooling fan state according to the vehicle lamp temperature in the vehicle lamp instruction comprises:
establishing a correlation between the vehicle lamp temperature and the rotational speed of the cooling fan to form a vehicle lamp temperature-rotational speed correlation table; calculating a theoretical rotational speed of the cooling fan according to a real-time monitored vehicle lamp temperature based on the vehicle lamp temperature-rotational speed correlation table; adjusting a rotational speed of the cooling fan within first preset time through a first segmented adjustment strategy according to the theoretical rotational speed, and continuously tracking a change of the vehicle lamp temperature; and once the vehicle lamp temperature is adjusted to meet the preset first temperature threshold, fixing the rotational speed of the cooling fan, thereby achieving a dynamic balanced state among heat dissipation efficiency, the vehicle lamp temperature, and an illumination intensity; and
the step of adjusting the liquid cooling state according to the vehicle lamp temperature in the vehicle lamp instruction comprises:
establishing a correlation between the vehicle lamp temperature and a flow velocity of a liquid cooling system to form a temperature-flow velocity comparison table; calculating a theoretical flow velocity of the liquid cooling system according to a present monitored vehicle lamp temperature based on the temperature-flow velocity comparison table; adjusting the flow velocity of the cooling liquid within second preset time through a second segmented adjustment strategy according to the theoretical flow velocity, and continuously monitoring a change of the vehicle lamp temperature; and when the vehicle lamp temperature is adjusted to reach a preset standard, allowing a system to stop increasing the flow velocity of the cooling liquid, thereby establishing a dynamic balanced state between water cooling efficiency, the vehicle lamp temperature, and the illumination intensity.

4. The heat dissipation method of the vehicle LED lamp according to claim 2, wherein the vehicle lamp instruction comprises at least intelligent control and gradual transition control when the LB sub-instruction, the HB sub-instruction, the DRL sub-instruction, the turn signal lamp sub-instruction, and the fog lamp sub-instruction are switched.

5. The heat dissipation method of the vehicle LED lamp according to claim 4, wherein the intelligent control comprises: automatically determining, by a system, an optimal illuminating mode; and intelligently selecting an LB, an HB, a DRL, a turn signal lamp or a fog lamp based on a vehicle speed, an external light condition, a weather condition, and a vehicle state, so as to provide an optimal field of view (FOV) and optimal safety; and
the gradual transition control comprises: receiving, by the system, a vehicle lamp mode switching instruction, calculating a required current changing curve from a present state to a target state through a preset algorithm, and gradually adjusting a current supplied to the vehicle LED lamp, wherein increasing or decreasing the current smoothly allows the vehicle lamp luminance to change gradually; continuously monitoring, by the system, a difference between present luminance and target luminance to ensure that a transition is proceeded according to a preset gradient curve; and when a deviation is detected, allowing a control unit to change a current adjustment strategy to ensure that final luminance is as expected.

6. A vehicle LED lamp, comprising a housing and a thermal superconductive tube provided in the housing, wherein an accommodating cavity and a heat dissipation cavity are formed in the housing;
an LED module and a vehicle LED lamp heat dissipation apparatus are provided in the accommodating cavity; the thermal superconductive tube comprises a heat conducting section and a cooling section; the heat conducting section contacts the LED module; the cooling section is wound in the heat dissipation cavity and contacts an inner wall of the heat dissipation cavity; the thermal superconductive tube is configured to conduct heat generated by illumination of the LED module to the housing and the heat dissipation cavity; a heat dissipation apparatus is provided in the heat dissipation cavity; the heat dissipation apparatus is opposite to the cooling section; the vehicle LED lamp heat dissipation apparatus is electrically connected to the LED module; and the vehicle LED lamp heat dissipation apparatus is configured to realize the heat dissipation method of the vehicle LED lamp according to claim 1.

7. The vehicle LED lamp according to claim 6, wherein the vehicle LED lamp heat dissipation apparatus comprises:
a preset module, configured to determine the preset first temperature threshold, the second temperature threshold, and the environmental temperature threshold correspondingly according to the vehicle lamp instruction;
a first data acquisition unit, configured to acquire the vehicle lamp instruction;
a second data acquisition unit, configured to acquire the vehicle lamp temperature, the vehicle lamp luminance, the cooling fan state, the liquid cooling state, and the external environmental temperature of the vehicle lamp in real time;
an output constructor, configured to evaluate a consistency between actual data and preset data, and generate a required rotational speed adjusted value based on a comparison; and
a control module, configured to start and adjust the cooling fan or the liquid cooling according to a received start signal.

8. The vehicle LED lamp according to claim 7, wherein
the vehicle lamp instruction comprises at least an LB sub-instruction, an HB sub-instruction, a DRL sub-instruction, a turn signal lamp sub-instruction, and a fog lamp sub-instruction; and
the control module comprises:
an air cooling control module, configured to send, when the vehicle lamp temperature is greater than a corresponding threshold, an air cooling start signal to a controller, and adjust the cooling fan state according to the vehicle lamp temperature or the external environmental temperature; and
a liquid cooling control module, configured to send, when the vehicle lamp temperature is greater than the second temperature threshold or the external environmental temperature is greater than the environmental temperature threshold, a liquid cooling start signal to the controller, and adjust the liquid cooling state according to the vehicle lamp temperature or the external environmental temperature.

9. A computer-readable storage medium, wherein the computer-readable storage medium stores a computer program, and the computer program is executed by a vehicle LED lamp heat dissipation apparatus to realize the heat dissipation method of the vehicle LED lamp according to claim 1.

10. A computer device, comprising a memory, a processor, and a computer program stored in the memory and executable on the processor, wherein the processor is configured to execute the computer program to realize the heat dissipation method of the vehicle LED lamp according to claim 1.

11. The vehicle LED lamp according to claim 6, wherein in the heat dissipation method of the vehicle LED lamp, the vehicle lamp instruction comprises at least a low beam (LB) sub-instruction, a high beam (HB) sub-instruction, a daytime running lamp (DRL) sub-instruction, a turn signal lamp sub-instruction, and a fog lamp sub-instruction; and the preset first temperature threshold, the second temperature threshold, and the environmental temperature threshold are different in the LB sub-instruction, the HB sub-instruction, the DRL sub-instruction, the turn signal lamp sub-instruction, and the fog lamp sub-instruction.

12. The vehicle LED lamp according to claim 6, wherein in the heat dissipation method of the vehicle LED lamp, the step of adjusting the cooling fan state according to the vehicle lamp temperature in the vehicle lamp instruction comprises:
establishing a correlation between the vehicle lamp temperature and the rotational speed of the cooling fan to form a vehicle lamp temperature-rotational speed correlation table; calculating a theoretical rotational speed of the cooling fan according to a real-time monitored vehicle lamp temperature based on the vehicle lamp temperature-rotational speed correlation table; adjusting a rotational speed of the cooling fan within first preset time through a first segmented adjustment strategy according to the theoretical rotational speed, and continuously tracking a change of the vehicle lamp temperature; and once the vehicle lamp temperature is adjusted to meet the preset first temperature threshold, fixing the rotational speed of the cooling fan, thereby achieving a dynamic balanced state among heat dissipation efficiency, the vehicle lamp temperature, and an illumination intensity; and
the step of adjusting the liquid cooling state according to the vehicle lamp temperature in the vehicle lamp instruction comprises:
establishing a correlation between the vehicle lamp temperature and a flow velocity of a liquid cooling system to form a temperature-flow velocity comparison table; calculating a theoretical flow velocity of the liquid cooling system according to a present monitored vehicle lamp temperature based on the temperature-flow velocity comparison table; adjusting the flow velocity of the cooling liquid within second preset time through a second segmented adjustment strategy according to the theoretical flow velocity, and continuously monitoring a change of the vehicle lamp temperature; and when the vehicle lamp temperature is adjusted to reach a preset standard, allowing a system to stop increasing the flow velocity of the cooling liquid, thereby establishing a dynamic balanced state between water cooling efficiency, the vehicle lamp temperature, and the illumination intensity.

13. The vehicle LED lamp according to claim 11, wherein the vehicle lamp instruction comprises at least intelligent control and gradual transition control when the LB sub-instruction, the HB sub-instruction, the DRL sub-instruction, the turn signal lamp sub-instruction, and the fog lamp sub-instruction are switched.

14. The vehicle LED lamp according to claim 13, wherein the intelligent control comprises: automatically determining, by a system, an optimal illuminating mode; and intelligently selecting an LB, an HB, a DRL, a turn signal lamp or a fog lamp based on a vehicle speed, an external light condition, a weather condition, and a vehicle state, so as to provide an optimal field of view (FOV) and optimal safety; and
the gradual transition control comprises: receiving, by the system, a vehicle lamp mode switching instruction, calculating a required current changing curve from a present state to a target state through a preset algorithm, and gradually adjusting a current supplied to the vehicle LED lamp, wherein increasing or decreasing the current smoothly allows the vehicle lamp luminance to change gradually; continuously monitoring, by the system, a difference between present luminance and target luminance to ensure that a transition is proceeded according to a preset gradient curve; and when a deviation is detected, allowing a control unit to change a current adjustment strategy to ensure that final luminance is as expected.

15. The computer-readable storage medium according to claim 9, wherein in the heat dissipation method of the vehicle LED lamp, the vehicle lamp instruction comprises at least a low beam (LB) sub-instruction, a high beam (HB) sub-instruction, a daytime running lamp (DRL) sub-instruction, a turn signal lamp sub-instruction, and a fog lamp sub-instruction; and the preset first temperature threshold, the second temperature threshold, and the environmental temperature threshold are different in the LB sub-instruction, the HB sub-instruction, the DRL sub-instruction, the turn signal lamp sub-instruction, and the fog lamp sub-instruction.

16. The computer-readable storage medium according to claim 9, wherein in the heat dissipation method of the vehicle LED lamp, the step of adjusting the cooling fan state according to the vehicle lamp temperature in the vehicle lamp instruction comprises:
establishing a correlation between the vehicle lamp temperature and the rotational speed of the cooling fan to form a vehicle lamp temperature-rotational speed correlation table; calculating a theoretical rotational speed of the cooling fan according to a real-time monitored vehicle lamp temperature based on the vehicle lamp temperature-rotational speed correlation table; adjusting a rotational speed of the cooling fan within first preset time through a first segmented adjustment strategy according to the theoretical rotational speed, and continuously tracking a change of the vehicle lamp temperature; and once the vehicle lamp temperature is adjusted to meet the preset first temperature threshold, fixing the rotational speed of the cooling fan, thereby achieving a dynamic balanced state among heat dissipation efficiency, the vehicle lamp temperature, and an illumination intensity; and
the step of adjusting the liquid cooling state according to the vehicle lamp temperature in the vehicle lamp instruction comprises:
establishing a correlation between the vehicle lamp temperature and a flow velocity of a liquid cooling system to form a temperature-flow velocity comparison table; calculating a theoretical flow velocity of the liquid cooling system according to a present monitored vehicle lamp temperature based on the temperature-flow velocity comparison table; adjusting the flow velocity of the cooling liquid within second preset time through a second segmented adjustment strategy according to the theoretical flow velocity, and continuously monitoring a change of the vehicle lamp temperature; and when the vehicle lamp temperature is adjusted to reach a preset standard, allowing a system to stop increasing the flow velocity of the cooling liquid, thereby establishing a dynamic balanced state between water cooling efficiency, the vehicle lamp temperature, and the illumination intensity.

17. The computer-readable storage medium according to claim 15, wherein the vehicle lamp instruction comprises at least intelligent control and gradual transition control when the LB sub-instruction, instruction, the HB sub-instruction, the DRL sub-instruction, the turn signal lamp sub-instruction, and the fog lamp sub-instruction are switched.

18. The computer-readable storage medium according to claim 17, wherein the intelligent control comprises: automatically determining, by a system, an optimal illuminating mode; and intelligently selecting an LB, an HB, a DRL, a turn signal lamp or a fog lamp based on a vehicle speed, an external light condition, a weather condition, and a vehicle state, so as to provide an optimal field of view (FOV) and optimal safety; and
the gradual transition control comprises: receiving, by the system, a vehicle lamp mode switching instruction, calculating a required current changing curve from a present state to a target state through a preset algorithm, and gradually adjusting a current supplied to the vehicle LED lamp, wherein increasing or decreasing the current smoothly allows the vehicle lamp luminance to change gradually; continuously monitoring, by the system, a difference between present luminance and target luminance to ensure that a transition is proceeded according to a preset gradient curve; and when a deviation is detected, allowing a control unit to change a current adjustment strategy to ensure that final luminance is as expected.

19. The computer device according to claim 10, wherein in the heat dissipation method of the vehicle LED lamp, the vehicle lamp instruction comprises at least a low beam (LB) sub-instruction, a high beam (HB) sub-instruction, a daytime running lamp (DRL) sub-instruction, a turn signal lamp sub-instruction, and a fog lamp sub-instruction; and the preset first temperature threshold, the second temperature threshold, and the environmental temperature threshold are different in the LB sub-instruction, the HB sub-instruction, the DRL sub-instruction, the turn signal lamp sub-instruction, and the fog lamp sub-instruction.

20. The computer device according to claim 10, wherein in the heat dissipation method of the vehicle LED lamp, the step of adjusting the cooling fan state according to the vehicle lamp temperature in the vehicle lamp instruction comprises:
establishing a correlation between the vehicle lamp temperature and the rotational speed of the cooling fan to form a vehicle lamp temperature-rotational speed correlation table; calculating a theoretical rotational speed of the cooling fan according to a real-time monitored vehicle lamp temperature based on the vehicle lamp temperature-rotational speed correlation table; adjusting a rotational speed of the cooling fan within first preset time through a first segmented adjustment strategy according to the theoretical rotational speed, and continuously tracking a change of the vehicle lamp temperature; and once the vehicle lamp temperature is adjusted to meet the preset first temperature threshold, fixing the rotational speed of the cooling fan, thereby achieving a dynamic balanced state among heat dissipation efficiency, the vehicle lamp temperature, and an illumination intensity; and
the step of adjusting the liquid cooling state according to the vehicle lamp temperature in the vehicle lamp instruction comprises:
establishing a correlation between the vehicle lamp temperature and a flow velocity of a liquid cooling system to form a temperature-flow velocity comparison table; calculating a theoretical flow velocity of the liquid cooling system according to a present monitored vehicle lamp temperature based on the temperature-flow velocity comparison table; adjusting the flow velocity of the cooling liquid within second preset time through a second segmented adjustment strategy according to the theoretical flow velocity, and continuously monitoring a change of the vehicle lamp temperature; and when the vehicle lamp temperature is adjusted to reach a preset standard, allowing a system to stop increasing the flow velocity of the cooling liquid, thereby establishing a dynamic balanced state between water cooling efficiency, the vehicle lamp temperature, and the illumination intensity.
